(19) United States
(12) Patent Application Publication
(10) Pub. No.: US 2025/0110090 A1
(43) Pub. Date: Apr. 3, 2025

(54) FLOW CORRECTION FOR BACK PRESSURE REGULATED RFF FLOW MODULATOR

(71) Applicant: LECO Corporation, St. Joseph, MI (US)

(72) Inventors: Mark Firmer Merrick, Bridgman, MI (US); David Jesse Borton, St. Joseph, MI (US)

(73) Assignee: LECO Corporation, St. Joseph, MI (US)

(21) Appl. No.: 18/897,621

(22) Filed: Sep. 26, 2024

Related U.S. Application Data
(60) Provisional application No. 63/587,553, filed on Oct. 3, 2023.

(51) Int. Cl. G01N 30/40; G01N 30/02; G01N 30/46

(52) U.S. Cl. CPC G01N 30/40; G01N 30/46; G01N 2030/025

(57) ABSTRACT

A method for flow correction includes, when an RFF flow modulator in a calibration flow condition, directing initial switching flow into the RFF flow modulator in a first direction to an exhaust with pressure regulation and reducing the initial switching flow to a minimum switching flow where a pressure satisfies a regulation condition. The calibration flow condition includes a primary column flow into the RFF flow modulator from a primary column and a secondary column flow from the RFF flow modulator to a secondary column. The operations include determining an adjusted switching flow for the calibration flow condition and determining a switching flow profile based on the adjusted switching flow. When the RFF flow modulator in an operating flow condition different from the calibration flow condition, the operations include directing an operating switching flow determined based on the switching flow profile in the first direction to the exhaust.

### CROSS REFERENCE TO RELATED APPLICATION

This U.S. patent application claims priority under 35 U.S.C. § 119 (e) to U.S. Provisional Application 63/587,553, filed on Oct. 3, 2023. The disclosure of this prior application is considered part of the disclosure of this application and is hereby incorporated herein by reference in its entirety.

### TECHNICAL FIELD

This disclosure relates to flow correction for back pressure regulated RFF flow modulators.

### BACKGROUND

Gas chromatography (GC) is an analytical technique used to separate and detect the chemical components of a sample mixture to determine their presence or absence and/or quantities. Fill/flush flow modulators are commonly used in GC and typically operate by collecting an amount of gas in a modulator channel (fill) and then quickly dispersing the gas outside of the modulator channel (flush). A reverse fill/flush (RFF) flow modulator flushes the modulator channel in the inverse direction to the direction in which the modulator channel is filled.

### SUMMARY

One aspect of the disclosure provides a computer-implemented method for flow correction for back pressure regulated RFF flow modulators. The computer-implemented method is executed by data processing hardware that causes the data processing hardware to perform operations. With a reverse fill/flush (RFF) flow modulator in a calibration flow condition, the operations include directing initial switching flow into the RFF flow modulator in a first direction to an exhaust with pressure regulation and reducing the initial switching flow to a minimum switching flow where a pressure of the RFF flow modulator satisfies a regulation condition. The calibration flow condition includes a primary column flow into the RFF flow modulator from a primary column and a secondary column flow from the RFF flow modulator to a secondary column. The operations include determining an adjusted switching flow for the calibration flow condition. The operations further include determining a switching flow profile based on the adjusted switching flow for the calibration flow condition. With the RFF flow modulator in an operating flow condition different from the calibration flow condition, the operations include directing an operating switching flow in the first direction to the exhaust. The operating switching flow is determined based on the switching flow profile.

Implementations of the disclosure may include one or more of the following optional features. In some implementations, determining the switching flow profile is based on a plurality of adjusted switching flows determined for a plurality of calibration flow conditions. In further implementations, the plurality of calibration flow conditions includes at least a first calibration flow condition including a primary column flow and a first secondary column flow, and a second calibration flow condition including the primary column flow and a second secondary column flow different from the first secondary column flow. In even further implementations, the first secondary column flow includes a minimum flow for the secondary column, and the second secondary column flow includes a maximum flow for the secondary column. In other further implementations, the plurality of calibration flow conditions includes a plurality of different primary column flows and a plurality of different secondary column flows. In some examples, the calibration flow condition includes a stable temperature.

In some aspects, reducing the initial switching flow includes lowering the switching flow until the pressure of the RFF flow modulator is not regulated. Further, incrementally increasing the switching flow until the pressure of the RFF flow modulator satisfies the regulation condition at the minimum switching flow. In some implementations, the regulation condition includes a minimum exhaust flow at the exhaust. In some examples, the adjusted switching flow is based on the minimum switching flow, the primary column flow and a curtain flow.

The operations may further include determining a fill volume of the RFF flow modulator based on the operating switching flow and a fill time. And the operations may further include directing the operating switching flow in a second direction to the secondary column for a flush time. The flush time is determined based on the fill volume.

Another aspect of the disclosure provides a system. The system includes memory hardware storing instructions that, when executed on data processing hardware in communication with the memory hardware, cause the data processing hardware to perform operations. With a reverse fill/flush (RFF) flow modulator in a calibration flow condition, the operations include directing initial switching flow into the RFF flow modulator in a first direction to an exhaust with pressure regulation and reducing the initial switching flow to a minimum switching flow where a pressure of the RFF flow modulator satisfies a regulation condition. The calibration flow condition includes a primary column flow into the RFF flow modulator from a primary column and a secondary column flow from the RFF flow modulator to a secondary column. The operations include determining an adjusted switching flow for the calibration flow condition. The operations further include determining a switching flow profile based on the adjusted switching flow for the calibration flow condition. With the RFF flow modulator in an operating flow condition different from the calibration flow condition, the operations include directing an operating switching flow in the first direction to the exhaust. The operating switching flow is determined based on the switching flow profile. This aspect may include one or more of the following optional features.

In some implementations, determining the switching flow profile is based on a plurality of adjusted switching flows determined for a plurality of calibration flow conditions. In further implementations, the plurality of calibration flow conditions includes at least a first calibration flow condition including a primary column flow and a first secondary column flow, and a second calibration flow condition including the primary column flow and a second secondary column flow different from the first secondary column flow. In even further implementations, the first secondary column flow includes a minimum flow for the secondary column, and the second secondary column flow includes a maximum flow for the secondary column. In other further implementations, the plurality of calibration flow conditions includes a plurality of different primary column flows and a plurality of different secondary column flows. In some examples, the calibration flow condition includes a stable temperature.

In some aspects, reducing the initial switching flow includes lowering the switching flow until the pressure of the RFF flow modulator is not regulated. Further, incrementally increasing the switching flow until the pressure of the RFF flow modulator satisfies the regulation condition at the minimum switching flow. In some implementations, the regulation condition includes a minimum exhaust flow at the exhaust. In some examples, the adjusted switching flow is based on the minimum switching flow, the primary column flow and a curtain flow.

The operations may further include determining a fill volume of the RFF flow modulator based on the operating switching flow and a fill time. And the operations may further include directing the operating switching flow in a second direction to the secondary column for a flush time. The flush time is determined based on the fill volume.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a back pressure regulated RFF flow modulator during a fill operation.

FIG. 2 is a schematic view of the RFF flow modulator during a flush operation.

FIG. 3 a flowchart of an example arrangement of operations for a method of flow correction for the RFF flow modulator.

FIG. 4 is a flowchart of an example arrangement of operations for another method of flow correction for the RFF flow modulator.

FIG. 5 is a schematic view of an example computing device that may be used to implement the systems and methods described herein.

FIG. 6 is a table including examples of errors in flow relative to nominal calculations of flow for the RFF flow modulator.

Like reference symbols in the various drawings indicate like elements.

### DETAILED DESCRIPTION

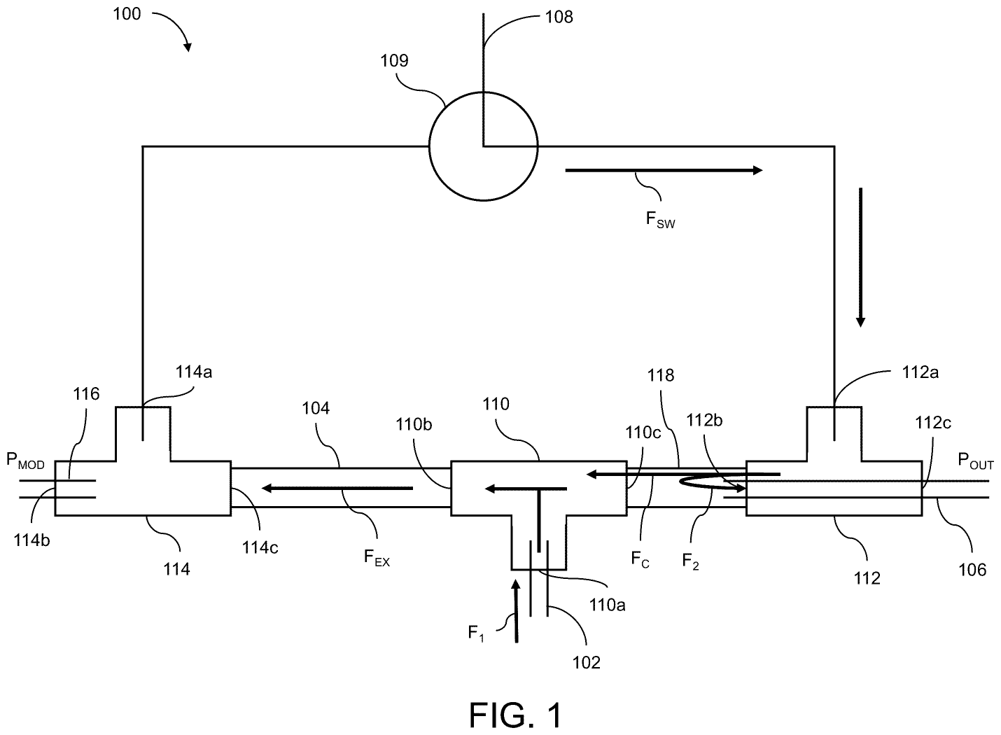

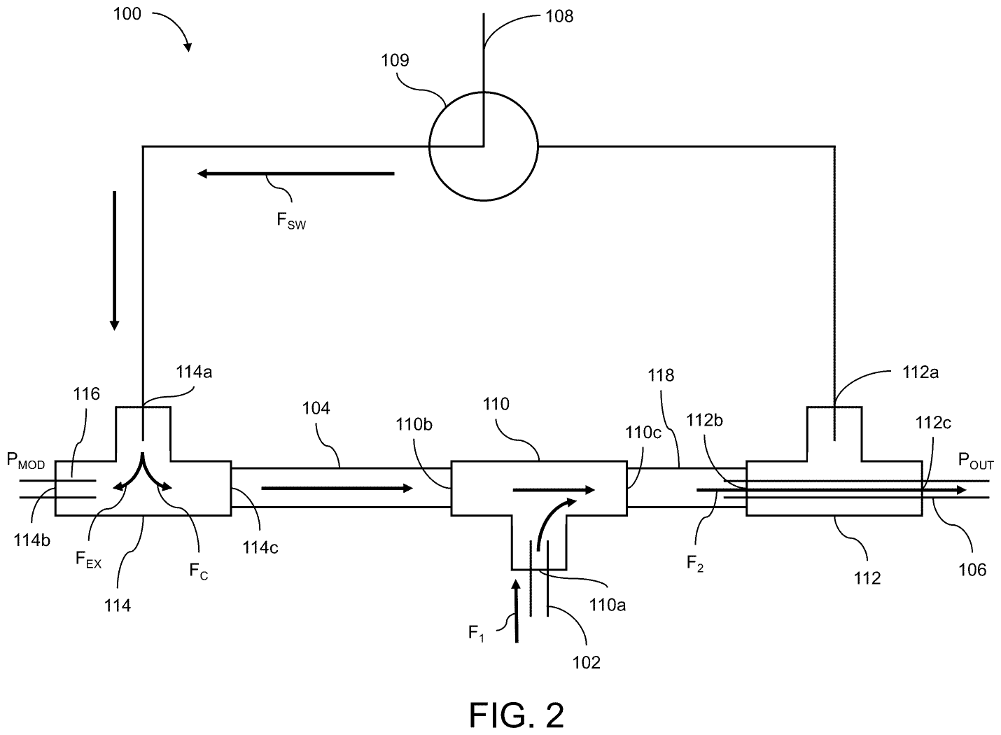

Referring now to the drawings and the illustrated configurations depicted therein, a back pressure regulated reverse fill/flush (RFF) flow modulator 100 includes a primary column 102 that delivers a sample to the RFF flow modulator 100, a sample loop 104 that collects the sample during a fill operation of the RFF flow modulator 100 (FIG. 1), and a secondary column 106 that carries the sample to a subsequent phase of a connected gas chromatography (GC) system during a flush operation of the RFF flow modulator 100 (FIG. 2). Flow from the primary column 102 to the RFF flow modulator 100 may be referred to as a primary column flow (F₁). Flow from the secondary column 106 to the GC system may be referred to as a secondary column flow (F₂). A pneumatic control module (PCM) 108 is connected to a switching valve 109 within the RFF flow modulator 100 and supplies a switching flow (F_{SW}) to the switching valve 109 for directing the sample from the primary column 102 to the sample loop 104 during the fill operation and for directing the sample from the sample loop 104 toward the secondary column 106 during the flush operation.

A first splitter or tee fitting 110 of the RFF flow modulator 100 fluidly connects to the primary column 102, the secondary column 106 and the sample loop 104. A second splitter or tee fitting 112 of the RFF flow modulator 100 fluidly connects to the primary column 102 and the sample loop 104 (via the first tee fitting 110), the secondary column 106 and the switching valve 109. A third splitter or tee fitting 114 of the RFF flow modulator 100 fluidly connects to the sample loop 104, the switching valve 109 and an exhaust tube or conduit 116 that provides back pressure regulation to the RFF flow modulator 100. A length of conduit 118 may extend between and space the first tee fitting 110 from the second tee fitting 112. Moreover, the PCM 108 may be configured to provide the switching flow (F_{SW}) via the switching valve 109 to only one of the second tee fitting 112 and the third tee fitting 114 at a given time.

In the illustrated example of FIGS. 1 and 2, a first end or channel 110a of the first tee fitting 110 is fluidly connected to the primary column 102 for receiving the primary column flow (F₁), a second end or channel 110b of the first tee fitting 110 is fluidly connected to an end of the sample loop 104, and a third end or channel 110c of the first tee fitting 110 is fluidly connected to an end of the conduit 118. A first end or channel 112a of the second tee fitting 112 is fluidly connected to the switching valve 109 for receiving the switching flow (F_{SW}), a second end or channel 112b of the second tee fitting 112 is fluidly connected to an end of the conduit 118 opposite the first tee fitting 110, and a third end or channel 112c of the second tee fitting 112 is fluidly connected to the secondary column 106. Pressure at the end or outlet of the secondary column 106 may be referred to as an outlet pressure (P_{OUT}). A first end or channel 114a of the third tee fitting 114 is fluidly connected to the switching valve 109 for receiving the switching flow (F_{SW}), a second end or channel 114b of the third tee fitting 114 is fluidly connected to the exhaust conduit 116, and a third end or channel 114c of the third tee fitting 114 is fluidly connected to an end of the sample loop 104 opposite the first tee fitting 110. Pressure for the RFF flow modulator 100 at the second end 114b of the third tee fitting 114 and/or the exhaust conduit 116 may be referred to as a modulator pressure (P_{MOD}). The modulator pressure (P_{MOD}) may be representative of pressure throughout the RFF flow modulator 100, assuming negligible restriction within the RFF flow modulator 100, and may be adjusted by pressure control means, as discussed further below.

During the fill operation (FIG. 1), the switching valve 109 directs the switching flow (F_{SW}) to the second tee fitting 112. A portion of the switching flow (F_{SW}) may exit the RFF flow modulator 100 along the secondary column 106 as secondary column flow (F₂) and the remaining switching flow (F_{SW}) flows along the conduit 118 toward the first tee fitting 110 and the sample loop 104. This remaining portion of the switching flow (F_{SW}) may be referred to as curtain flow (F_{C}). The outlet pressure (Pour) may be lower than the modulator pressure (P_{MOD}) during the fill operation to draw the secondary column flow (F₂) along the secondary column 106. However, the pressure within the RFF flow modulator 100 may be at least slightly higher toward the second tee fitting 112 as compared to toward the third tee fitting 114 where modulator pressure (P_{MOD}) is controlled at the exhaust 116 so that the curtain flow (F_{C}) may mix with the primary column flow (F₁) and flow toward and into the sample loop 104 and toward the exhaust conduit 116. This may be referred to as load flow or exhaust flow (F_{EX}). Thus, the switching flow (F_{SW}) is directed to the second tee fitting 112 during the fill operation so that the curtain flow (F_{C}) prevents the sample of the primary column flow (F₁) from flowing to the secondary column 106 and instead the curtain flow (F_{C}) and the primary column flow (F₁) fill the sample loop 104.

Thus, during the fill operation, the curtain flow (F_{C}) may be represented as:

$${F}_{C} = {F}_{S W} - {F}_{2} \qquad ( 1 )$$

and the load flow or exhaust flow (F_{EX}) that fills the sample loop 104 may be represented as:

$${F}_{E X} = {F}_{1} + {F}_{C} \qquad ( 2 )$$

As discussed further below, the fill operation minimizes the curtain flow (F_{C}) to maximize the amount of sample present in the sample loop 104 while preventing primary column flow (F₁) from flowing to the secondary column 106 and the fill operation minimizes the sample lost to the exhaust conduit 116 while maximizing the fill of the sample loop 104. This is accomplished by controlling the switching flow (F_{SW}) and more specifically by controlling a time of the fill operation during which the switching flow (F_{SW}) is directed to the second tee fitting 112.

In other words, the switching flow (F_{SW}) feeds the secondary column 106 and supplies a small curtain flow (F_{C}) that prevents the breakthrough of sample from the primary column 102 to the secondary column 106 by diffusion. The sample volume (volume between the third tee fitting 114 and the first tee fitting 110) must not be overfilled (lose sample) and the volume filled must be known in order to calculate how much to flush the sample volume. The fill volume (time) depends on the sum of the primary column flow (F₁) and the curtain flow (F_{C}) and the fill time. Calculation of an accurate fill volume (time) depends on accurate flows.

During the flush operation (FIG. 2), the switching valve 109 directs the switching flow (F_{SW}) to the third tee fitting 114. The switching flow (F_{SW}) may be the same for the flush operation and the fill operation. A portion of the switching flow (F_{SW}) may exit the RFF flow modulator 100 along the exhaust conduit 116 as exhaust flow (F_{EX}) and the remaining switching flow (F_{SW}) acts as an injection flow or flushing flow (F_{FLUSH}) and flows along the sample loop 104 to force the sample toward the secondary column 106. As the flushing flow (F_{FLUSH}) forces the sample toward the secondary column 106, additional sample from the primary column flow (F₁) may also flow toward the secondary column 106 and exit the RFF flow modulator 100 along the secondary column 106 with the sample and the flushing flow (F_{FLUSH}) as the secondary column flow (F₂). The outlet pressure (P_{OUT}) is lower (e.g. significantly lower) than the modulator pressure (P_{MOD}) during the flush operation. Thus, the switching flow (F_{SW}) is directed to the third tee fitting 114 during the flush operation to evacuate the sample loop 104 to the secondary column 106 for further analysis using the GC system.

With flow into the RFF flow modulator 100 during the flush operation equal to flow out of the RFF modulator 100, the flow balance of the RFF flow modulator 100 may be represented as:

$${F}_{S W} + {F}_{1} = {F}_{2} + {F}_{E X} \qquad ( 3 )$$

With back pressure regulation providing the exhaust flow (F_{EX}), the flushing flow (F_{FLUSH}) during the flush operation may be represented as:

$${F}_{FLUSH} = {F}_{S W} - {F}_{1} - {F}_{C} = {F}_{2} - {F}_{1} \qquad ( 4 )$$

and the secondary column flow (F₂) may be represented as:

$${F}_{2} = {F}_{F L U S H} + {F}_{1} \qquad ( 5 )$$

In other words, during the flush operation, the switching flow (F_{SW}) is switched from a Load state (where the switching valve 109 directs the switching flow (F_{SW}) to the second tee fitting 112) to an Inject state (where the switching valve 109 directs the switching flow (F_{SW}) to the third tee fitting 114). In the Inject state the switching flow (F_{SW}) splits at the third tee fitting 114, with part (a smaller portion) of the switching flow (F_{SW}) going to the exhaust conduit 116 and the majority of the switching flow (F_{SW}) going through the sample loop 104 to flush the sample. At the first tee fitting 110, the flushing flow (F_{FLUSH}) combines with the primary column flow (F₁) to feed the secondary column 106 and provide the secondary column flow (F₂). This flush or inject flow may be referred to as the flushing flow (F_{FLUSH}) and is (F₂−F₁).

To accurately flush the filled volume, the flows must be accurately known. Two major results of inaccurate flush include that less than a near complete flush can result in sample loss and that over flushing can result in poor peak shapes due to sample from the primary column flow (F₁) continuing to the secondary column 106 after the sample loop 104 has been flushed. Further, the time needed to perform the flush operation is minimized to allow for detection of defined peaks by the GC system while minimizing the occurrence of shoulders or tails in the detected peaks due to additional flow of sample to the GC. The time needed to perform the flush operation may be referred to as an injection time (T_{INJECT}). As discussed further below, the injection time (T_{INJECT}) is determined based on a load time of a fill operation (T_{LOAD}) as accurate measurements of the flow rates and flow volumes during the fill operation and flush operation is impractical. Thus, determining accurate load times (T_{LOAD}) and injection times (T_{INJECT}) leads to more accurate peak detection at the downstream GC system. Where (P_{M}) represents a modulation period equal to the total injection time (T_{INJECT}) and load time (T_{LOAD}) and (x) represents a flush factor, factor times fill volume, injection time (T_{INJECT}) may be represented as:

$${T}_{INJECT} = \frac{x ( {F}_{1} + {F}_{C} ) {P}_{M}}{( {F}_{2} - {F}_{1} ) + ( x ( {F}_{1} + {F}_{C} ) )} \qquad ( 6 )$$

(6)

The calculation of fill and flush timing of the RFF flow modulator 100 requires relatively accurate flow calculations. These calculations depend on the dimensions of the primary column 102 and the secondary column 106. The accuracy of the flow calculations for the columns is limited by the accuracy and precision of the dimensions of the columns. The lengths of columns can be accurately measured, but it is inconvenient and not generally done. Further, the internal diameter (ID) of the columns are only nominally known and vary within some manufacturing tolerance (which vary to a degree that actual flows can be approximately 10 percent higher or lower than the flow calculated based on nominal dimensions). The variance in the ID, in addition to the approximate column lengths, cause the variations in column flow to be as much as 20 percent higher or lower than calculated.

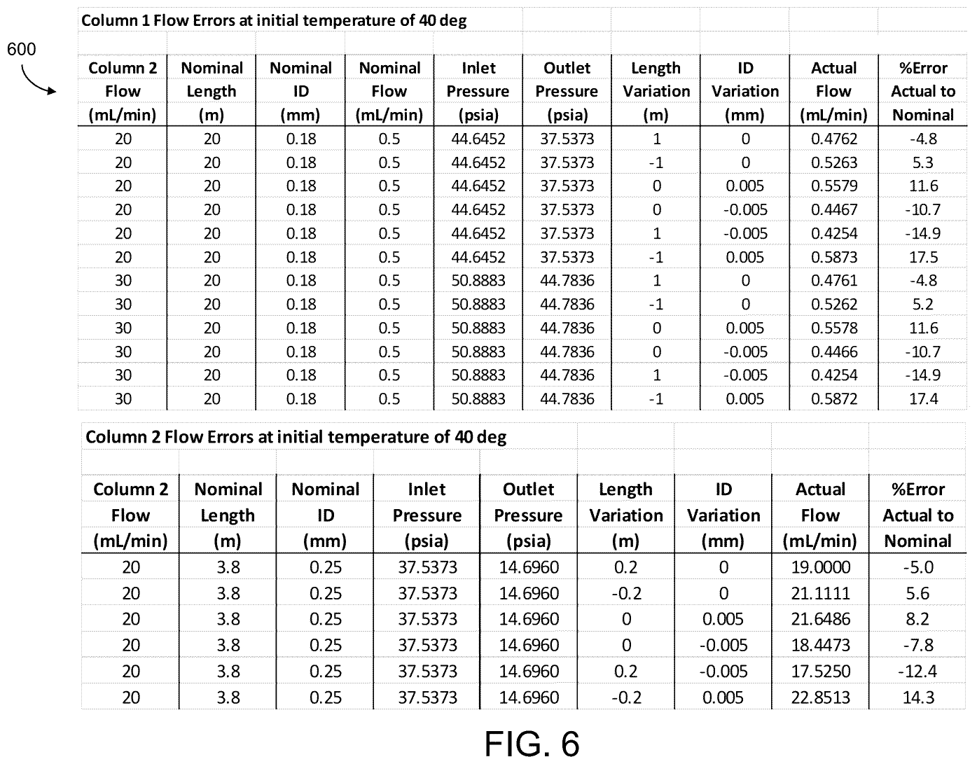

Known systems have deficiencies in the calculations for RFF flow modulators. For example, the flows for the primary column 102 and the secondary column 106 can be calculated using the Hagen-Poiseuille equation for capillary tubing; however, the calculations are based on nominal dimensions so the resulting calculated flows are somewhat inaccurate. These inaccuracies are enough to make it difficult, if not impossible, to calculate sufficiently accurate fill and flush volumes (times). Lengths of the columns can be measured precisely (although this is not easy), but generally they are not measured precisely (and there is a lack of motivation to measure the length of these columns in current systems). For example, the primary column 102 could be shorter or longer by a meter or two, while the shorter secondary column 106 (which is usually cut by the user) may be shorter or longer by ten or more centimeters. To expect a user to cut the columns with a precision of a few centimeters is not realistic and for general gas chromatography it is not required. In addition to the length the ID of the capillary also varies within some manufacturing tolerance. These tolerances vary with manufacturer and the ID, but all are approximately in a tolerance range of plus or minus 0.003 millimeters to 0.010 millimeters for columns having internal diameters of 0.100 millimeters to 0.320 millimeters. These variations are unknown and for general gas chromatography are not of concern; however, for fill and flush volumes (times) they can be significant. The table 600 in FIG. 6 includes examples of errors in flow relative to the nominal calculation of flow.

For example, there is a significant impact of the error in the secondary column flow (F₂) on the curtain flow (F_{C}). A relatively small and normally acceptable error in the secondary column flow (F₂) of 5 percent is 1 milliliter per minute for a secondary column flow (F₂) of 20 milliliters per minute. However, this 1 milliliter per minute difference in the excess or insufficient flow from the switching flow (F_{SW}) results in a very large change in the curtain flow (F_{C}). Generally, a curtain flow of 0.2 milliliters per minute is sufficient. A 1 milliliter per minute decrease in the secondary column flow (F₂) provides an additional 1 milliliter per minute flow to the curtain flow (F_{C}), resulting in a fill volume (time) that is more than 100 percent in error relative to the nominal calculation. If the secondary column flow (F₂) increases by 1 milliliter per minute, the additional flow above the nominal requires flow to come from the primary column 102 and the curtain flow (F_{C}) goes to zero. This results in sample breakthrough. It also decreases the flow (F_{EX}) to the exhaust conduit 116 which may then be insufficient and result in the back pressure regulation failing.

During the fill (load) operation, the fill of the sample loop 104 depends on the primary column flow (F₁) and the curtain flow (F_{C}) (the excess switching flow (F_{SW}) that prevents sample breakthrough from the primary column 102 to the secondary column 106), while the flush depends on the switching flow (F_{SW}) less the sum of the primary column flow (F₁) and the curtain flow (F_{C}). Fill and flush times based on inaccurate flows can result in poor quantification (less than full transfer or overfill resulting in sample lost out the exhaust conduit 116), sample break through, and poor peak shapes detected by the GC system. Variations in the large secondary column flow (F₂) can have a significant effect on the curtain flow (F_{C}) and thus the fill volume (time). For example, if the secondary column flow (F₂) is lower than the nominally calculated flow, the curtain flow (F_{C}) will be excessive and the fill volume greater than calculated as well as excessive dilution of the sample. If the secondary column flow (F₂) is higher than the nominally calculated, the curtain flow (F_{C}) will be too low (or even zero) and sample breakthrough to the secondary column 106 will occur during the fill period. Similarly, but less so, the variation of the primary column flow (F₁) also impacts the fill and flush volumes. Thus, to compensate for variations in the column flows relative to calculated flows based on nominal column dimensions, the switching flow (F_{SW}) is adjusted.

Known RFF flow modulators, which use a fixed capillary restrictor on the exhaust, require manual (user involved) adjustments to account for flow variations (due to dimensional variations in the columns and the restrictor) to provide relatively accurate fill and flush timing. Similarly, a known RFF flow modulator using back pressure regulation to control the exhaust flow requires adjustment of the switching flow (done manually by user) to account for inaccurate flows calculated based on nominal dimensions.

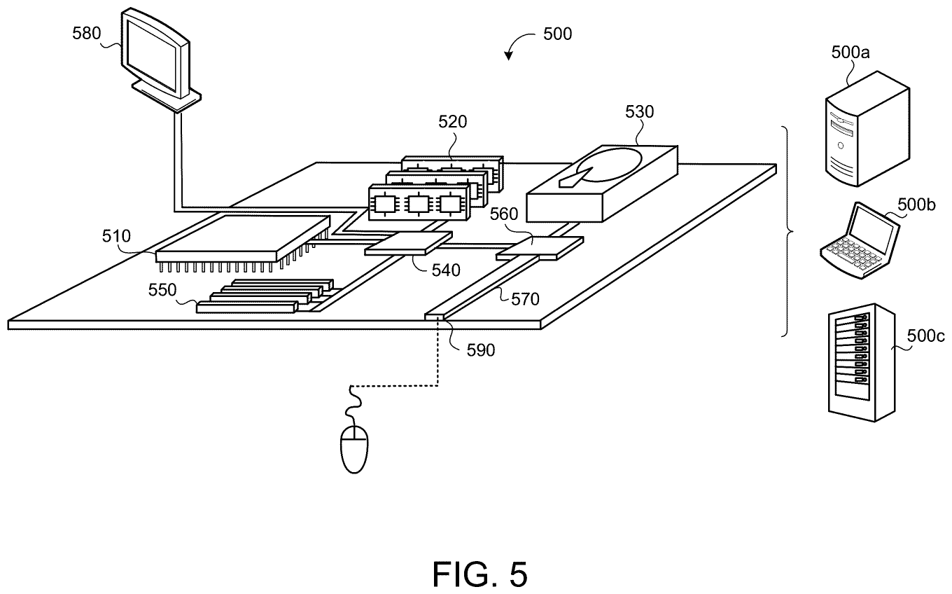

Implementations herein are directed to an automatic software controlled procedure (no user input required) that adjusts the switching flow (F_{SW}) of the back pressure regulated RFF flow modulator 100 to account for dimensional variations in the primary column 102 and the secondary column 106 and variations in the minimum required exhaust flow (F_{EX}) to provide a sufficiently accurate curtain flow (F_{C}) and relatively accurate fill and flush timing. For example, the PCM 108 includes and/or is in communication with data processing hardware 510 (FIG. 5) and memory hardware 520 (FIG. 5). The memory hardware 520 stores instructions that, when executed on the data processing hardware 510, cause the data processing hardware 510 to perform operations. The memory hardware 520 stores instructions for operating the PCM 108 to control the switching flow (F_{SW}) supplied to the switching valve 109 during the fill operation and the flush operation, as discussed further below.

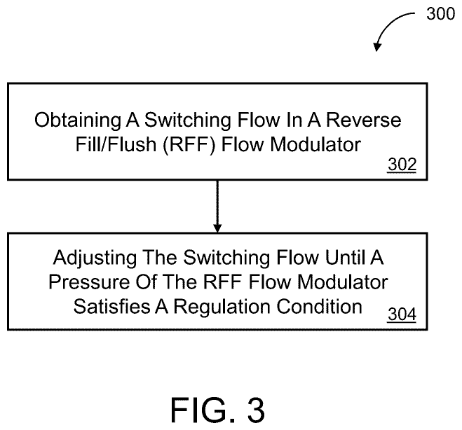

FIG. 3 is a flowchart of an exemplary arrangement of operations for a method 300 of flow correction for back pressure regulated RFF flow modulators. The method 300 can be performed, for example, by the computing device 500 of FIG. 5. At operation 302, the method 300 includes obtaining a switching flow (F_{SW}) in the RFF flow modulator 100. At operation 304, the method 300 includes adjusting the switching flow (F_{SW}) until a pressure (P_{MOD}) of the RFF flow modulator 100 satisfies a regulation condition.

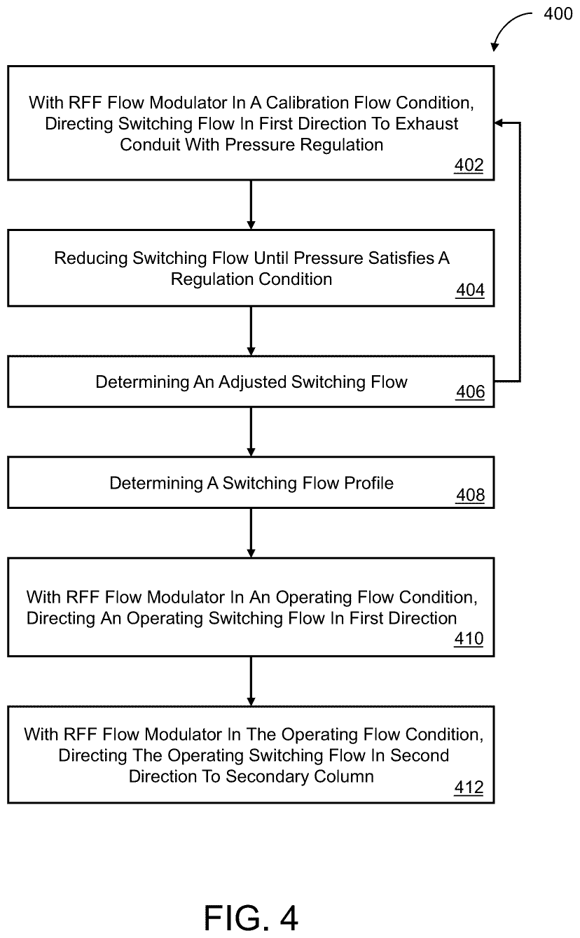

FIG. 4 is a flowchart of an exemplary arrangement of operations for a method 400 of flow correction for the back pressure regulated RFF flow modulator 100. The method 400 can be performed, for example, at the RFF flow modulator 100 by the computing device 500 of FIG. 5 that is disposed at or in communication with the PCM 108. At operation 402, with the RFF flow modulator 100 in a flow condition, the method 400 includes directing initial switching flow (F_{SW}) into the RFF flow modulator 100 in a first direction to the pressure regulated exhaust conduit 116. The flow condition may include a primary column flow (F₁) into the RFF flow modulator 100 from the primary column 102 and a secondary column flow (F₂) from the RFF flow modulator 100 to the secondary column 106. The initial switching flow (F_{SW}) may be set based on a nominal secondary column flow (F₂) and a curtain flow (F_{C}) (e.g., about 0.2 milliliters per minute). At operation 404, the method 400 includes reducing the switching flow (F_{SW}) to a minimum switching flow (F_{SW}) where the pressure (P_{MOD}) of the RFF flow modulator 100 satisfies a regulation condition. For example, reducing the initial switching flow (F_{SW}) may include lowering the switching flow (F_{SW}) until the pressure (P_{MOD}) of the RFF flow modulator 100 is not regulated (e.g., exhaust flow (F_{EX}) is no longer present at the exhaust conduit 116) and incrementally increasing the switching flow (F_{SW}) until the pressure (P_{MOD}) of the RFF flow modulator 100 satisfies the regulation condition at the minimum switching flow (F_{SW}). The regulation condition may include a minimum pressure (P_{MOD}) of the RFF flow modulator 100 at the exhaust conduit 116, such as a minimum pressure for a minimum level of exhaust flow (F_{EX}) to reach the exhaust conduit 116 (e.g., about 0.1 milliliters per minute). Thus, the minimum switching flow (F_{SW}) may be based on the actual secondary column flow (F₂), the actual primary column flow (F₁), and the minimal exhaust flow (F_{EX}).

At operation 406, the method 400 includes determining an adjusted switching flow (F_{SW}) for the flow condition. For example, with the minimum switching flow (F_{SW}) calibrated to the actual primary column flow (F₁) of the flow condition and the actual secondary column flow (F₂) of the flow condition, the adjusted switching flow (F_{SW}) is determined based on the minimum switching flow (F_{SW}), the primary column flow (F₁) of the flow condition, the secondary column flow (F₂) of the flow condition, and a desired minimum curtain flow (F_{C}) such as about 0.2 milliliters per minute. Thus, at the flow condition, the adjusted switching flow (F_{SW}) is configured to provide a minimum curtain flow (F_{C}) for preventing sample breakthrough to the secondary column 106 while satisfying the pressure regulation condition and filling the sample loop 104 during a fill operation. At operation 408, the method 400 includes determining a switching flow profile based on the adjusted switching flow (F_{SW}) for the flow condition. The switching flow profile is configured to be applicable to the RFF flow modulator 100 to provide adjusted switching flows (F_{SW}) under various flow conditions.

Operations 402, 404 and 406 may be repeated as necessary to determine the switching flow profile. That is, these operations may be performed during a calibration procedure for the RFF flow modulator 100 so that the switching flow profile is based on a plurality of adjusted switching flows (F_{SW}) determined for a plurality of flow conditions. In some examples, the switching flow profile is based on at least a first adjusted switching flow (F_{SW}) for a first calibration flow condition and a second adjusted switching flow (F_{SW}) for a second calibration flow condition. The first and second calibration flow conditions may include the same primary column flow (F₁) into the RFF flow modulator 100 from the primary column 102 and different secondary column flows (F₂) from the RFF flow modulator 100 to the secondary column 106, such as a minimum secondary column flow (F₂) (e.g., about 20 milliliters per minute) and a maximum secondary column flow (F₂) (e.g., about 30 milliliters per minute or more, about 35 milliliters per minute or more, and the like). In other words, the switching flow profile is based on a plurality of adjusted switching flows (F_{SW}) corresponding to a plurality of calibration flow conditions and the plurality of flow conditions include a first calibration flow condition including a primary column flow (F₁) and a first secondary column flow (F₂) and a second calibration flow condition including the primary column flow (F₁) and a second secondary column flow (F₂) different from the first secondary column flow (F₂). The calibration flow conditions may include a stable temperature at the RFF flow modulator 100.

In some examples, the switching flow profile includes a multi-factorial response surface. Thus, the switching flow profile is determined based on results from an array of calibration flow conditions that vary both the primary column flow (F₁) and the secondary column flow (F₂). That is, the switching flow profile is based on a plurality of calibration flow conditions having a plurality of different primary column flows (F₁) and a plurality of different secondary column flows (F₂). The plurality of calibration flow conditions thus includes at least a first adjusted switching flow (F_{SW}) for a first calibration flow condition and a second adjusted switching flow (F_{SW}) for a second calibration flow condition where the first calibration flow condition includes a first primary column flow (F₁) and a first secondary column flow (F₂) and the second calibration flow condition includes a different second primary column flow (F₁) and a different second secondary column flow (F₂).

Thus, with the switching flow profile or the multi-factorial response surface determined, the calibrated RFF flow modulator 100 may be operated to perform fill and flush operations with accurate fill and flush volumes or times. For example, at operation 410, the method 400 includes, with the RFF flow modulator 100 in an operating flow condition (e.g., different from the calibration flow condition), directing an operating switching flow (F_{SW}) in the first direction to the exhaust conduit 116 to provide the curtain flow (F_{C}) and fill the sample loop 104 where the switching flow (F_{SW}) is determined based on the switching flow profile. At operation 412, the method 400 includes determining a fill volume of the RFF flow modulator 100 based on the operating switching flow (F_{SW}) and a fill time of the fill operation and directing the operating switching flow (F_{SW}) in a second direction to the secondary column 106. The flush operation switching flow (F_{SW}) may be equal to the fill operation switching flow (F_{SW}) and a flush time of the flush operation is determined based on the fill volume to completely and accurately flush the sample in the sample loop 104 to the secondary column 106.

In other words, an automatic procedure adjusts the switching flow (F_{SW}) such that it provides the secondary column flow (F₂) plus the small (approximately 0.2 milliliters per minute) curtain flow (F_{C}). That is, the procedure adjusts the flow balance to account for the variation in flows from the nominal. The procedure may include setting the flow conditions to typical flow conditions at stable or consistent temperature conditions, increasing the nominally calculated switching flow (F_{SW}) to some reasonable level to account for a possible high secondary column flow (F₂), then automatically adjusting the switching flow (F_{SW}) down until the pressure (P_{MOD}) is no longer regulated and then back up to the point of just enough to pressure regulate. At this point the switching flow (F_{SW}) plus the primary column flow (F₁) may be just sufficient to feed the secondary column 106 and an amount of excess that goes to the exhaust conduit 116 which is sufficient for pressure regulation. The switching flow value (F_{SW}) is then added to the primary column flow (F₁) and the desired curtain flow (F_{C}) (typically 0.2 milliliters per minute) for the new switching flow values (F_{SW}). This may be done at the minimum secondary column flow (F₂) allowed (such as about 20 milliliters per minute) and the maximum (such as about 30 to 35 milliliters per minute). A switching flow profile is established, such as a linear equation with a slope and offset, from these two points for the switching flow (F_{SW}) determined at the sufficient regulation point at each flow condition. This slope and offset are used to determine the adjusted switching flow (F_{SW}) at different secondary column flows (F₂) which is then used to calculate the required switching flow (F_{SW}) based on the primary column flow (F₁) and curtain flow (F_{C}). This approach assumes a small flow (such as about 0.2 milliliters per minute) is required at the exhaust conduit 116 for back pressure regulation. The required exhaust flow (F_{EX}) may be unknown. Note the procedure can all be done under software control. This procedure may be performed when either or both of the primary column 102 and the secondary column 106 are changed and/or periodically over time. Optionally, when the primary column 102 and the secondary column 106 remain consistent between fill and flush operations, the calibration process may not need to be repeated.

Further, when the minimum flow to the exhaust conduit 116 is not small, or known, a more complex procedure can be done. For example, the adjusted switching flow (F_{SW}) may be determined several times at different primary column flows (F₁) and secondary column flow (F₂). A two-level or three-level factorial of flows may be used. At each flow combination (factorial treatment) the calibration process may be performed to determine the adjusted switching flow (F_{SW}). This switching flow (F_{SW}) is then regressed against the nominally calculated flows used to create a response surface. The results of the regression are regression coefficients for the primary column flow (F₁) and the secondary column flow (F₂) that corrects the nominal flow to an actual flow relative to the flow value of the switching flow (F_{SW}). These corrected flows can then be used to calculate an appropriate switching flow (F_{SW}) for the desired primary column flow (F₁) and the secondary column flow (F₂) and curtain flow (F_{C}) based on the flow balance equations. The constant of the regression is for the required minimum flow to back pressure regulate. If this flow is variable over the conditions tested, it may have to be included as a variable and additional treatments (conditions) added for it.

In other words, implementations provide for automatically adjusting the switching flow (F_{SW}) of the back pressure regulated RFF flow modulator 100. These implementations do not require user input in the calibration of the RFF flow modulator 100. Further, implementations herein do not require precise measurements of columns and/or other minor restrictions within the RFF manifold. The “fill” procedure may be calculated based on a primary column flow (F₁), a curtain flow (F_{C}), a secondary column flow (F₂), and a switching flow (F_{SW}). In some implementations, variations in the secondary column flow (F₂) can result in large variation in the curtain flow (F_{C}) (and subsequently in the fill volume time). As described above, if the fill volume is not correct, the flush procedure will also be impacted. Thus, the switching flow (F_{SW}) may be automatically adjusted to provide a proper curtain flow (F_{C}). In some implementations, the switching flow (F_{SW}) is set at a high level and then gradually reduced until the pressure (P_{MOD}) does not regulate (called the zero point). At the zero point, the curtain flow (F_{C}) may then be added to the switching flow (F_{SW}).

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
when a reverse fill/flush (RFF) flow modulator is in a calibration flow condition including a primary column flow into the RFF flow modulator from a primary column and a secondary column flow from the RFF flow modulator to a secondary column, directing initial switching flow into the RFF flow modulator in a first direction to an exhaust with pressure regulation and reducing the initial switching flow to a minimum switching flow where a pressure of the RFF flow modulator satisfies a regulation condition;
determining an adjusted switching flow for the calibration flow condition;
determining a switching flow profile based on the adjusted switching flow for the calibration flow condition;
determining an operating switching flow based on the switching flow profile; and
with the RFF flow modulator is in an operating flow condition different from the calibration flow condition, directing the operating switching flow in the first direction to the exhaust.

2. The method of claim 1, wherein determining the switching flow profile is based on a plurality of adjusted switching flows determined for a plurality of calibration flow conditions.

3. The method of claim 2, wherein the plurality of calibration flow conditions comprises:
a first calibration flow condition including the primary column flow and a first secondary column flow; and
a second calibration flow condition including the primary column flow and a second secondary column flow different from the first secondary column flow.

4. The method of claim 3, wherein:
the first secondary column flow comprises a minimum flow for the secondary column; and
the second secondary column flow comprises a maximum flow for the secondary column.

5. The method of claim 2, wherein the plurality of calibration flow conditions comprises a plurality of different primary column flows and a plurality of different secondary column flows.

6. The method of claim 1, wherein the calibration flow condition comprises a stable temperature.

7. The method of claim 1, wherein reducing the initial switching flow comprises:
lowering the switching flow until the pressure of the RFF flow modulator is not regulated; and
incrementally increasing the switching flow until the pressure of the RFF flow modulator satisfies the regulation condition at the minimum switching flow.

8. The method of claim 1, wherein the regulation condition comprises a minimum exhaust flow at the exhaust.

9. The method of claim 1, wherein the adjusted switching flow is based on the minimum switching flow, the primary column flow, and a curtain flow.

10. The method of claim 1, wherein the operations further comprise:
determining a fill volume of the RFF flow modulator based on the operating switching flow and a fill time; and
directing the operating switching flow in a second direction to the secondary column for a flush time, the flush time determined based on the fill volume.

11. A system comprising:
data processing hardware; and
memory hardware in communication with the data processing hardware and storing instructions that, when executed on the data processing hardware, causes the data processing hardware to perform operations comprising:
when a reverse fill/flush (RFF) flow modulator is in a calibration flow condition including a primary column flow into the RFF flow modulator from a primary column and a secondary column flow from the RFF flow modulator to a secondary column, directing initial switching flow into the RFF flow modulator in a first direction to an exhaust with pressure regulation and reducing the initial switching flow to a minimum switching flow where a pressure of the RFF flow modulator satisfies a regulation condition;
determining an adjusted switching flow for the calibration flow condition;
determining a switching flow profile based on the adjusted switching flow for the calibration flow condition;
determining an operating switching flow based on the switching flow profile; and
with the RFF flow modulator is in an operating flow condition different from the calibration flow condition, directing the operating switching flow in the first direction to the exhaust.

12. The system of claim 11, wherein determining the switching flow profile is based on a plurality of adjusted switching flows determined for a plurality of calibration flow conditions.

13. The system of claim 12, wherein the plurality of calibration flow conditions comprises:
a first calibration flow condition including the primary column flow and a first secondary column flow; and
a second calibration flow condition including the primary column flow and a second secondary column flow different from the first secondary column flow.

14. The system of claim 13, wherein:
the first secondary column flow comprises a minimum flow for the secondary column; and
the second secondary column flow comprises a maximum flow for the secondary column.

15. The system of claim 12, wherein the plurality of calibration flow conditions comprises a plurality of different primary column flows and a plurality of different secondary column flows.

16. The system of claim 11, wherein the calibration flow condition comprises a stable temperature.

17. The system of claim 11, wherein reducing the initial switching flow comprises:
lowering the switching flow until the pressure of the RFF flow modulator is not regulated; and
incrementally increasing the switching flow until the pressure of the RFF flow modulator satisfies the regulation condition at the minimum switching flow.

18. The system of claim 11, wherein the regulation condition comprises a minimum exhaust flow at the exhaust.

19. The system of claim 11, wherein the adjusted switching flow is based on the minimum switching flow, the primary column flow, and a curtain flow.

20. The system of claim 11, wherein the operations further comprise:
determining a fill volume of the RFF flow modulator based on the operating switching flow and a fill time; and
directing the operating switching flow in a second direction to the secondary column for a flush time, the flush time determined based on the fill volume.
